(19) United States
(12) Patent Application Publication
(10) Pub. No.: US 2026/0296440 A1
(43) Pub. Date: Oct. 1, 2026

(54) CONTROL DEVICE, CONTROL METHOD, AND STORAGE MEDIUM

(71) Applicant: HONDA MOTOR CO., LTD., Tokyo (JP)

(72) Inventors: Shoei TOMIKAWA, Tokyo (JP); Shohei NOAI, Tokyo (JP)

(73) Assignee: HONDA MOTOR CO., LTD., Tokyo (JP)

(21) Appl. No.: 19/575,609

(22) Filed: Mar. 23, 2026

(30) Foreign Application Priority Data
Mar. 26, 2025 (JP) 2025-051634

(51) Int. Cl. B60W 30/18; B60W 30/182; B60W 50/14; G05D 1/2285; G05D 107/13; G05D 109/10

(52) U.S. Cl. CPC B60W 30/18163; B60W 30/182; B60W 50/14; G05D 1/2285; B60W 2050/143; B60W 2050/146; B60W 2520/105; B60W 2540/215; B60W 2540/223; G05D 2107/13; G05D 2109/10

(57) ABSTRACT

A control device of a vehicle, the control device including a processor configured to: acquire surrounding information of the vehicle; receive, from an inputter provided in a passenger compartment of the vehicle, a first input with contact and a second input by at least one of a gesture and a voice by an occupant of the vehicle; and perform a travel control of the vehicle using the surrounding information and start the travel control of a lane change for performing the lane change based on at least the first input. The processor is configured to start the travel control of the lane change based on the second input in a first driving mode in which gripping a steering wheel by the occupant is not required and monitoring surroundings outside the vehicle by the occupant is required.

This application is based upon and claims the benefit of priority from prior Japanese patent application No. 2025-51634, filed on Mar. 26, 2025, the entire contents of which are incorporated herein by reference.

### TECHNICAL FIELD

The present disclosure relates to a control device, a control method, and a storage medium.

### BACKGROUND ART

In recent years, active efforts have been made to provide access to a sustainable transportation system in consideration of vulnerable people among traffic participants. For implementing the above object, research and development for further improving traffic safety and convenience through research and development related to an autonomous driving technology (including a driving assistance technology) have been focused on.

As one of autonomous driving technologies, active lane change assist (ALCA) and active lane change recommendation (ALCR) are known. In the ALCA, a vehicle system autonomously performs a lane change based on an operation of a turn signal lever by an occupant of the vehicle. In the ALCR, the vehicle system makes a proposal for a lane change to the occupant, and the vehicle system autonomously performs the lane change based on a switch operation or the like of the occupant who approves a proposal.

In relation to improvement of traffic safety and convenience, research and development on a user interface for an occupant to access various functions of a vehicle have also been performed. A vehicle control device described in JP2019-114188A recognizes a gesture of an occupant of another vehicle, and controls steering and/or acceleration/deceleration when the recognized gesture is a predetermined gesture. The predetermined gesture is, for example, a gesture expressing giving way.

A vehicle control device described in JP2020-192877A can receive an input by a switch and an input by a gesture, and enables the input by the gesture by receiving the input by a predetermined switch. The gesture is, for example, a movement of the face of the occupant, a movement of the head, or a movement of the line of sight, and controls functions such as navigation by a navigation device, display of a television program, and switching between a manual driving mode and a driving assistance mode based on an input by the gesture.

### SUMMARY OF INVENTION

The autonomous driving is typically divided into a plurality of levels, and a subject of driving and a traveling area are mainly determined for each level. As the level rises and the subject of driving shifts from the occupant to the system, gripping a steering wheel by the occupant is not required, and monitoring surroundings by the occupant is not required.

An operation of the turn signal lever for starting the ALCA and an operation of a button for approving the ALCR during hands-off traveling in which the gripping the steering wheel is not required may be a burden on the occupant. Aspects of the present disclosure relate to reducing a burden on an occupant who uses a lane change by autonomous driving.

According to an aspect of the present disclosure, there is provided a control device of vehicle, the control device including a processor configured to:
acquire surrounding information of the vehicle;
receive, from an inputter provided in a passenger compartment of the vehicle, a first input with contact and a second input by at least one of a gesture and a voice by an occupant of the vehicle; and
perform a travel control of the vehicle using the surrounding information and start the travel control of a lane change for performing the lane change based on at least the first input, in which
the processor is configured to start the travel control of the lane change based on the second input in a first driving mode in which gripping a steering wheel by the occupant is not required and monitoring surroundings outside the vehicle by the occupant is required.

It is possible to reduce the burden on the occupant who uses the lane change by autonomous driving.

### BRIEF DESCRIPTION OF DRAWINGS

Exemplary embodiment(s) of the present invention will be described in detail based on the following figures, wherein:

FIG. 1 is a side view of an example of a vehicle for illustrating an embodiment of the present invention;

FIG. 2 is a plan view of the vehicle of FIG. 1;

FIG. 3 is a functional block diagram of the vehicle of FIG. 1;

FIG. 4 is a flowchart of a travel control of a lane change performed by a processor;

FIG. 5 is a diagram schematically illustrating a flow of the lane change;

FIG. 6 is a diagram schematically illustrating a flow of the lane change;

FIG. 7 is a flowchart of a travel control of the lane change;

FIG. 8 is a diagram schematically illustrating a flow of the lane change;

FIG. 9 is a diagram schematically illustrating a flow of the lane change performed by the controller;

FIG. 10 is a diagram schematically illustrating a detection range of a target in the travel control of the lane change;

FIG. 11 is a diagram schematically illustrating a flow of canceling the lane change; and

FIG. 12 is a flowchart of a process of canceling the lane change in the travel control of the lane change.

### DESCRIPTION OF EMBODIMENTS

An example of a vehicle for illustrating an embodiment of the present disclosure will be described with reference to the accompanying drawings. The drawings are viewed from directions of reference numerals. In the present specification and the like, in order to simplify and clarify the description, a front-rear direction, a left-right direction, and an upper-lower direction are described according to directions viewed from a driver of a vehicle. In the drawings, a front side of the vehicle is illustrated as Fr, a rear side is illustrated as Rr, a left side is illustrated as L, a right side is illustrated as R, an upper side is illustrated as U, and a lower side is illustrated as D.

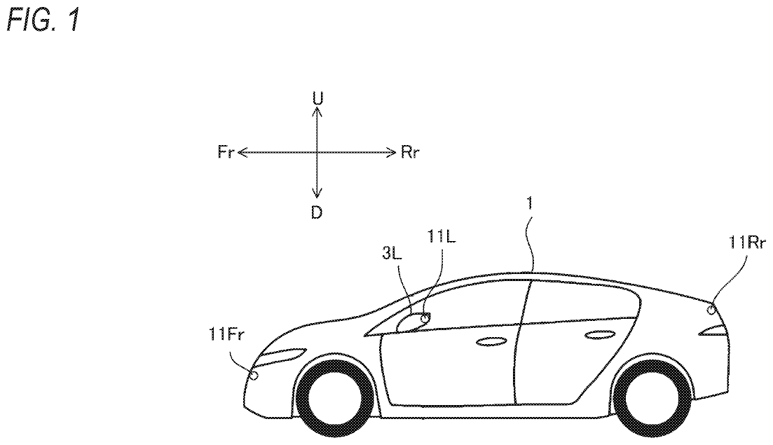

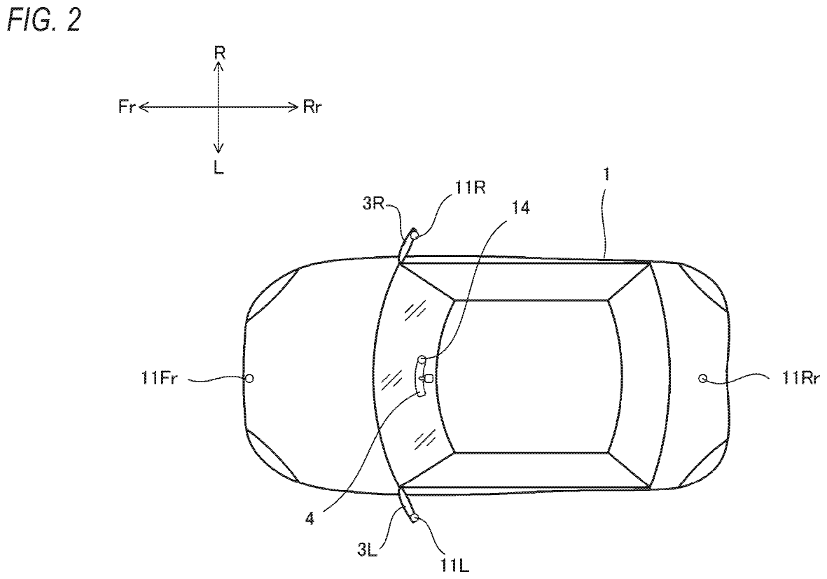

A vehicle 1 illustrated in FIGS. 1 and 2 is a four-wheeled automobile including a pair of left and right front wheels and a pair of left and right rear wheels. A drive source of the vehicle 1 is an internal combustion engine such as a gasoline engine or a diesel engine, an electric motor, or a combination of the internal combustion engine and the electric motor. Both the pair of left and right front wheels and the pair of left and right rear wheels may be driven by the drive source, or any one of the pair of left and right front wheels and the pair of left and right rear wheels may be driven by the drive source. Alternatively, both the pair of left and right front wheels and the pair of left and right rear wheels may be steered wheels that are steerable, or any one of the pair of left and right front wheels and the pair of left and right rear wheels may be steered wheels.

The vehicle 1 includes side mirrors 3L and 3R and a rearview mirror 4. The side mirrors 3L and 3R are mirrors for an occupant to check a rear side and rear lateral sides and are provided on outer sides of front seat doors of the vehicle 1. The rearview mirror 4 is a mirror for the occupant to check the rear, and is provided at the upper center of a front window in a passenger compartment of the vehicle 1.

The vehicle 1 includes a front camera 11Fr, a rear camera 11Rr, a left side camera 11L, a right side camera 11R, and an in-vehicle camera 14. The front camera 11Fr is a digital camera (image sensor) that images a front side of the vehicle 1 and is provided at a front portion of the vehicle 1. The rear camera 11Rr is a digital camera that images a rear side of the vehicle 1 and is provided at a rear portion of the vehicle 1. The left side camera 11L is a digital camera that images a left side of the vehicle 1 and is provided on the side mirror 3L on the left side of the vehicle 1. The right side camera 11R is a digital camera that images a right side of the vehicle 1 and is provided on the side mirror 3R on the right side of the vehicle 1. The in-vehicle camera 14 is a digital camera that images interior of the vehicle 1, and is provided in the rearview mirror 4.

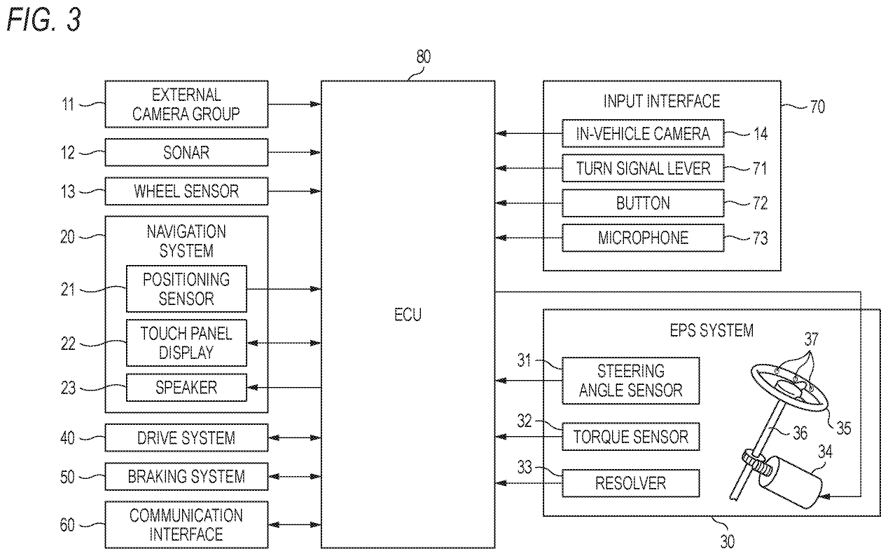

As illustrated in FIG. 3, the vehicle 1 includes, a navigation system 20, an electric power steering (EPS) system 30, a drive system 40, a braking system 50, a communication interface 60, an input interface 70, a sensor group, and an electronic control unit (ECU) 80 that integrally controls the devices.

The navigation system 20 includes a positioning sensor 21 that detects a current position of the vehicle 1, a touch panel display 22, a speaker 23, and a memory that stores map information. The positioning sensor 21 is, for example, a global positioning system (GPS) sensor. The navigation system 20 guides a travel route to a destination to an occupant based on position information of the vehicle 1 detected by the positioning sensor 21 and the map information stored in the memory. The guidance is presented to the occupant through the touch panel display 22 or the speaker 23.

The EPS system 30 includes a steering angle sensor 31, a torque sensor 32, a resolver 33, and an EPS motor 34. The steering angle sensor 31 detects a steering angle of a steering wheel 35. The torque sensor 32 detects a torque applied to the steering wheel 35. The resolver 33 detects a rotation angle of the EPS motor 34. Based on the steering angle, the torque, and the rotation angle, the ECU 80 operates the EPS motor 34 to assist the occupant in operating the steering wheel 35, for example, and applies a driving force or a reaction force to a steering column 36 coupled to the steering wheel 35.

The drive system 40 operates a power source or the like of the vehicle 1 under the control of the ECU 80 to drive wheels of the vehicle 1. The braking system 50 operates a brake mechanism or the like of the vehicle 1 under the control of the ECU 80 to brake the wheels of the vehicle 1. The ECU 80 controls the drive system 40 and the braking system 50 according to, for example, an accelerator pedal operation, a brake operation, and a shift operation by the occupant.

The communication interface 60 performs wireless communication with another communication device under the control of the ECU 80. The other communication device includes a sensor or a communication device installed in a traffic infrastructure, a communication device mounted on another vehicle, an information terminal such as a smartphone carried by an occupant of the vehicle 1, and the like.

In communication with the sensor or the communication device installed in the traffic infrastructure, the ECU 80 acquires, for example, road traffic information on a travel route. In communication with the communication device mounted on the other vehicle, the ECU 80 acquires state information such as acceleration/deceleration of a preceding vehicle or a following vehicle, for example.

The ECU 80 includes a processor and a memory that stores programs to be executed by the processor and various types of data to be used during the execution of the programs. By the processor operating according to the programs, the ECU 80 realizes the various functions described above, such as steering operation assistance, a driving force control, and a braking force control. The ECU 80 may include a plurality of processors divided for respective functions such as the steering operation assistance, the driving force control, and the braking force control.

Then, the ECU 80 can perform autonomous driving by causing the navigation system 20, the EPS system 30, the drive system 40, and the braking system 50 to cooperate with each other using various pieces of information of the vehicle 1 acquired by the sensor group. Examples of the functions of the autonomous driving performed by the ECU 80 include an adaptive cruise control (ACC) for realizing constant speed traveling of the vehicle 1 at a set speed or following traveling of a preceding vehicle, lane keeping assist (LKA) for maintaining traveling of the vehicle 1 in a lane, and a travel control of a lane change in the ALCA and the ALCR described above.

The information acquired by the sensor group is roughly divided into surrounding information of the vehicle 1, state information of the vehicle 1, and state information of the occupant. A sensor that acquires the surrounding information of the vehicle 1 includes an external camera group 11 including the front camera 11Fr, the rear camera 11Rr, the left side camera 11L, and the right side camera 11R, and the sonar 12. A sensor that acquires the state information of the vehicle 1 includes the wheel sensor 13, the positioning sensor 21 of the navigation system 20, and the steering angle sensor 31 of the EPS system 30. A sensor that acquires the state information of the occupant includes the in-vehicle camera 14 and a grip sensor 37 provided in the steering wheel 35.

The external camera group 11 acquires a front image, a rear image, a left side image, and a right side image of the vehicle 1. The ECU 80 performs image recognition on the image acquired by the external camera group 11, and detects a road surface marking such as a division line (a roadway center line, a lane boundary line, and a roadway outer line) drawn on the road surface around the vehicle 1 and a target present around the vehicle 1.

The sonar 12 emits sound waves to the surroundings of the vehicle 1 and receives a reflected sound. The ECU 80 detects the target present in the surroundings of the vehicle 1 based on a direction of the received reflected sound and a time from the emission of the sound waves to the reception of the reflected sound and detects a direction and a distance in which the detected target is present.

The sensor that acquires the surrounding information of the vehicle 1 may include other sensors such as a radar and a light detection and ranging or laser imaging detection and ranging (Lidar).

As described above, the autonomous driving is divided into a plurality of levels, and for each level, it is determined whether the gripping the steering wheel by the occupant is required and whether the monitoring the surroundings by the occupant is required, and a traveling area is determined. In some levels, conditions such as traffic conditions, vehicle speeds, and time periods may be further determined.

The wheel sensor 13 detects rotation angles of the respective wheels including the pair of left and right front wheels and the pair of left and right rear wheels of the vehicle 1. The wheel sensor 13 is, for example, an angle sensor or a displacement sensor, and outputs a pulse signal each time the wheel rotates by a predetermined angle. The ECU 80 calculates the rotation angle and a rotation speed of each wheel from the pulse signal output from the wheel sensor 13 and further calculates a speed and a moving distance of the vehicle 1.

The positioning sensor 21 detects the current position of the vehicle 1. The ECU 80 determines to which traveling area the current position of the vehicle 1 belongs based on the current position of the vehicle 1 and the map information stored in the memory. The traveling area is divided into a general road, a motorway, an expressway, and the like.

The in-vehicle camera 14 acquires an image of the interior of the vehicle 1, particularly the occupant. The ECU 80 performs image recognition on the image acquired by the in-vehicle camera 14, detects a movement of the head and a movement of the line of sight of the occupant, and determines whether the occupant is monitoring the surroundings.

The grip sensor 37 measures a pressure or capacitance applied to the steering wheel 35. The ECU 80 determines whether the occupant is gripping the steering wheel 35 based on the output of the grip sensor 37.

The ECU 80 sets the autonomous driving level based on the traveling area to which the current position of the vehicle 1 belongs, the vehicle speed, and the like. The ECU 80 notifies the occupant whether the gripping the steering wheel is required and the monitoring the surroundings is required at the set autonomous driving level through display by the touch panel display 22 and/or voice by the speaker 23.

When a necessary condition (gripping the steering wheel and monitoring the surroundings) at the set autonomous driving level is not satisfied, the ECU 80 issues a warning to the occupant through the display by the touch panel display 22 and/or the voice by the speaker 23. Then, in a case where the necessary condition is not satisfied even after an appropriate grace time has elapsed from the warning, the ECU 80 requests the occupant to transition from the autonomous driving to manual driving through the display by the touch panel display 22 and/or the voice by the speaker 23. Further, when the occupant does not respond to a request for transition to the manual driving, a travel control for reducing a risk is performed, for example, by decelerating the vehicle 1 and stopping the vehicle 1 on a road shoulder.

The input interface 70 provides the occupant with access to the travel control of the lane change performed by the ECU 80. The input interface 70 is configured to allow the occupant to perform a first input with contact and a second input by at least one of a gesture and a voice, and in the example illustrated in FIG. 3, the first input includes a turn signal lever 71 and a button 72, and the second input includes the in-vehicle camera 14 and a microphone 73.

The turn signal lever 71 is a lever for turning on a direction indicator (a turn signal lamp) when changing the course, and is typically provided behind the steering wheel 35. When the ECU 80 receives the operation of the turn signal lever 71, the ECU 80 starts the travel control of the lane change in the ALCA. Instead of the turn signal lever 71, the steering wheel 35 may be provided with a switch. The turn signal lever 71 may be used to approve a proposal of the lane change performed by the ECU 80.

The button 72 is a button for approving the proposal of the lane change performed by the ECU 80. The proposal for the lane change is made by, for example, the display by the touch panel display 22 and/or the voice by the speaker 23. The button 72 may be a physical button provided on the steering wheel 35, a dashboard, or the like, or may be an image displayed on the touch panel display 22. When the operation of the button 72 is received, the ECU 80 starts the travel control of the lane change in the ALCR.

The microphone 73 is provided in the passenger compartment of the vehicle 1 and acquires voice in the passenger compartment. The ECU 80 performs voice recognition on the voice acquired by the microphone and detects a lane change instruction by the voice of the occupant. For example, when an instruction such as “change lanes to the right lane” or “overtake the preceding vehicle” is received, the ECU 80 starts the travel control of the lane change in the ALCA. Further, in response to the proposal of the lane change performed by the ECU 80, for example, when an instruction of an approval such as “ok” is received, the ECU 80 starts the travel control of the lane change in the ALCR, and when an instruction of rejection such as “no” is received, the ECU 80 postpones the start of the travel control of the lane change in the ALCR.

The in-vehicle camera 14 acquires an image of the occupant. The ECU 80 performs the image recognition on the image acquired by the in-vehicle camera 14, and detects the lane change instruction by the gesture of the occupant. For example, when a gesture of pointing to a lane to be changed is received, the ECU 80 starts the travel control of the lane change in the ALCA. In response to the proposal of the lane change performed by the ECU 80, for example, when a gesture indicating an intention of an approval such as nodding is received, the ECU 80 starts the travel control of the lane change in the ALCR, and when a gesture indicating an intention of rejection such as shaking the head is received, the ECU 80 postpones the start of the travel control of the lane change in the ALCR. Instead of the in-vehicle camera 14 or in addition to the in-vehicle camera 14, another sensor such as a Lidar may be used to detect a gesture.

The ECU 80 has three driving modes, that is, a first driving mode in which the gripping the steering wheel by the occupant is not required and the monitoring the surroundings by the occupant is required, a second driving mode in which the gripping the steering wheel is not required and the monitoring the surroundings is not required, and a third driving mode in which the gripping the steering wheel is required and the monitoring the surroundings is required, based on whether the gripping the steering wheel by the occupant is required and whether the monitoring the surroundings by the occupant is required.

In the first driving mode, the second driving mode, and the third driving mode, the ECU 80 can start the travel control of the lane change based on the first input of the turn signal lever 71 and the button 72. On the other hand, the ECU 80 can start the travel control of the lane change based on the second input of the in-vehicle camera 14 and the microphone 73 in the first driving mode, and does not perform the travel control of the lane change based on the second input in the second driving mode and the third driving mode.

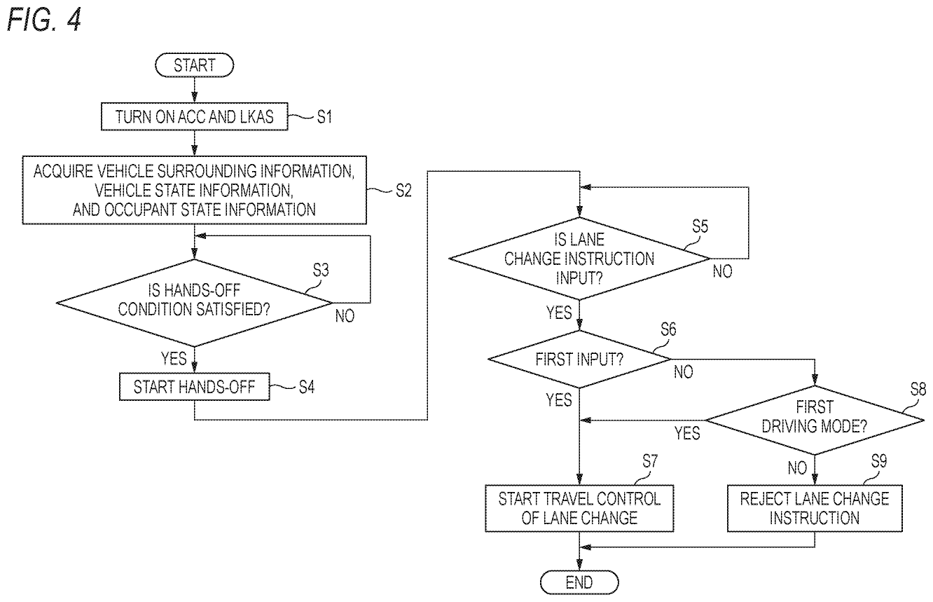

FIG. 4 illustrates an example of a process of the travel control of the lane change in the ALCA performed by the ECU 80. FIG. 4 illustrates a case where the lane change instruction is input by the occupant when the first driving mode or the second driving mode is set.

First, the ACC and the LKAS are turned on by the occupant (step S1). When the ECU 80 receives the turning-on operation of the ACC and the LKAS, the ECU 80 starts the autonomous driving in the third driving mode and starts acquiring various information including the surrounding information of the vehicle 1, the state information of the vehicle 1, and the state information of the occupant (step S2). Then, when a hands-off condition (a traveling area, a vehicle speed, or the like) that the gripping the steering wheel by the occupant is required is satisfied (step S3), the ECU 80 transitions to hands-off traveling in the first driving mode or the second driving mode (step S4).

In a case where the ECU 80 detects that the lane change instruction is input to the input interface 70 by the occupant (step S5), when the input is the first input (step S6—Yes), the ECU 80 receives the first input and starts the travel control of the lane change (step S7). Then, the lane change is completed, and the process ends.

When the input is the second input (step S6—No), the ECU 80 determines whether the set driving mode is the first driving mode (step S8). When it is determined that the driving mode is the first driving mode (step S8—Yes), the ECU 80 receives the second input, proceeds to step S7, and starts the travel control of the lane change. In this case, the ECU 80 may notify the occupant that the second input is received through the display by the touch panel display 22 and/or the voice by the speaker 23 before starting the travel control of the lane change.

During the hands-off traveling, an action of the occupant reaching for the turn signal lever 71 or the like in order to instruct the lane change may be a burden on the occupant, but the burden on the occupant is reduced by enabling the lane change instruction by a gesture or a voice.

On the other hand, when it is determined that the driving mode is not the first driving mode (step S8—No), the ECU 80 rejects the second input (step S9), and ends the process without starting the travel control of the lane change. In this case, the ECU 80 may notify the occupant that the second input is not received through the display by the touch panel display 22 and/or the voice by the speaker 23.

In the second driving mode, the occupant is allowed to perform a second activity other than driving. In such a situation, various gestures and voices of the occupant can be acquired. Therefore, the ECU 80 does not perform the travel control of the lane change based on the second input in the second driving mode. Accordingly, it is possible to prevent a lane change unintended by the occupant due to erroneous recognition of the ECU 80.

Although not illustrated, even in the third driving mode before the hands-off condition is satisfied, the lane change instruction of the occupant can be input to the input interface 70. When the input is the first input, the ECU 80 receives the first input and starts the travel control of the lane change. On the other hand, when the input is the second input, the ECU 80 rejects the second input and ends the process without starting the travel control of the lane change.

During the third driving mode, that is, during hands-on traveling, the hands of the occupant grip the steering wheel 35 and are near the turn signal lever 71 and the like. Therefore, it is easier for the occupant to operate the turn signal lever 71 or the like than during the hands-off traveling. Therefore, in the third driving mode, no particular problem occurs even when the travel control of the lane change based on the second input is not performed.

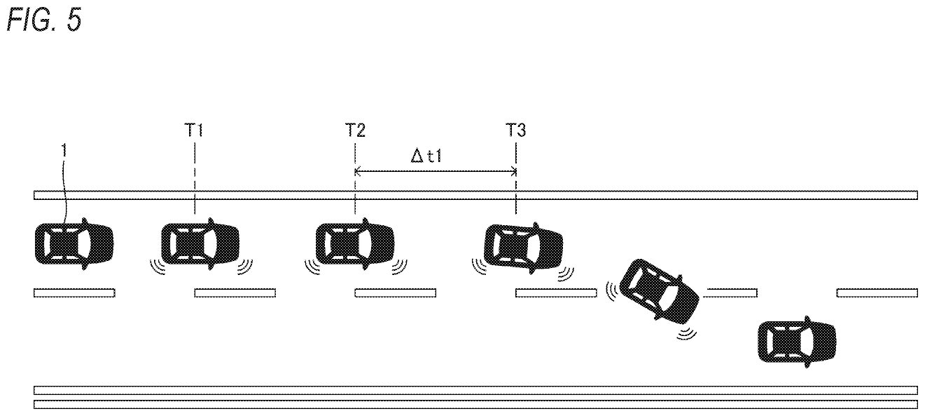

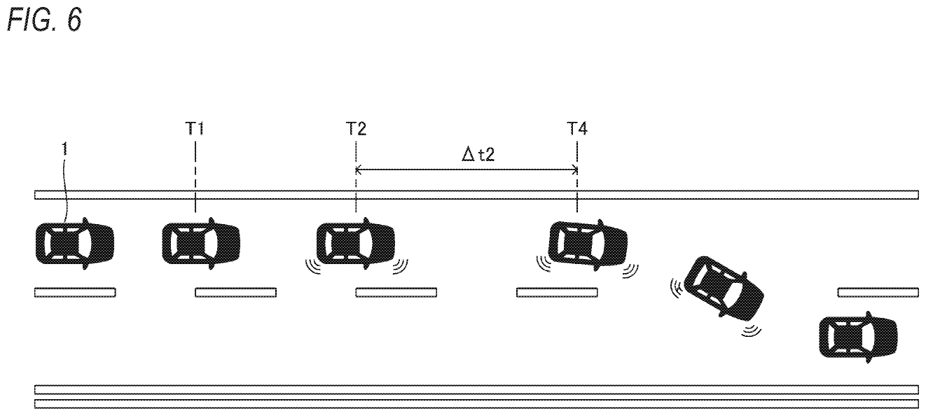

FIGS. 5 and 6 schematically illustrate a flow of the lane change in the ALCA performed by the ECU 80.

FIG. 5 illustrates a flow of the travel control of the lane change based on the first input, in which the occupant operates the turn signal lever 71 or the like to perform the first input for instructing the lane change at a time point T1. The ECU 80 turns on a direction indicator of the vehicle 1 in response to an operation of the turn signal lever 71 or the like. At a time point T2, the ECU 80 receives the first input. At a time point T3 when a predetermined waiting time Δt1 has elapsed from the time point T2, the ECU 80 starts the travel control of the lane change based on the first input.

FIG. 6 illustrates a flow of the travel control of the lane change based on the second input, in which the occupant performs the second input for instructing the lane change by a gesture or a voice at the time point T1. At the time point T2, the ECU 80 receives the second input and turns on the direction indicator of the vehicle 1. Then, at a time point T4 when a predetermined waiting time Δt2 has elapsed from the time point T2, the ECU 80 starts the travel control of the lane change based on the second input.

In FIGS. 5 and 6, the ECU 80 performs the travel control of the lane change (a lateral movement control in a lane width direction accompanying the lane change) after the input (the first input or the second input) of the occupant. The waiting time Δt1 from the first input to the start of the travel control of the lane change and the waiting time Δt2 from the second input to the start of the travel control of the lane change are grace times for canceling the start of the travel control of the lane change. The waiting time Δt2 may be set to be the same as the waiting time Δt1, but is preferably set to be longer than the waiting time Δt1. When the ECU 80 erroneously recognizes the second input by the gesture or the voice, the occupant can be given time to cancel the start of the travel control of the lane change.

The cancellation of the start of the travel control of the lane change may be performed by, for example, the first input such as an operation of returning the turn signal lever 71 to a neutral position or an operation of a cancel button, or may be performed by the second input such as a gesture of opening a clenched hand while swinging down the hand or a voice such as “cancel the lane change”.

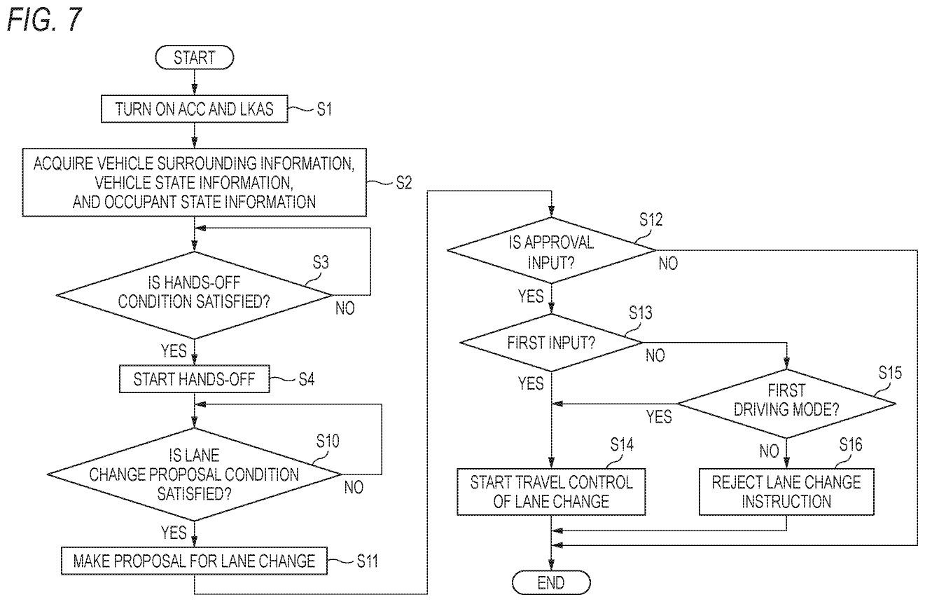

FIG. 7 illustrates the process of the travel control of the lane change in the ALCR performed by the ECU 80. FIG. 7 illustrates a case where the occupant inputs the lane change when the first driving mode or the second driving mode is set.

First, the ACC and the LKAS are turned on by the occupant (step S1). When the ECU 80 receives the turning-on operation of the ACC and the LKAS, the ECU 80 starts the autonomous driving in the third driving mode and starts acquiring various information including the surrounding information of the vehicle 1, the state information of the vehicle 1, and the state information of the occupant (step S2). Then, when a hands-off condition (a traveling area, a vehicle speed, or the like) that the gripping the steering wheel by the occupant is not required is satisfied (step S3), the ECU 80 transitions to hands-off traveling in the first driving mode or the second driving mode (step S4).

When a lane change proposal condition is satisfied (step S10), the ECU 80 makes the proposal for the lane change to the occupant through the display by the touch panel display 22 and/or the voice by the speaker 23 (step S11).

In a case where the ECU 80 detects that the approval for the proposal is input to the input interface 70 within a predetermined time from the proposal of the lane change (step S12), when the input is the first input (step S13—Yes), the ECU 80 receives the first input and starts the travel control of the lane change (step S14). Then, the lane change is completed, and the process ends.

When the input is the second input (step S13—No), the ECU 80 determines whether the set driving mode is the first driving mode (step S15). When it is determined that the driving mode is the first driving mode (step S15—Yes), the ECU 80 receives the second input, proceeds to step S14, and starts the travel control of the lane change. In this case, the ECU 80 may notify the occupant that the second input is received through the display by the touch panel display 22 and/or the voice by the speaker 23.

During the hands-off traveling, the action of the occupant reaching for the turn signal lever 71 or the like in order to instruct the lane change may be a burden on the occupant, but the burden on the occupant is reduced by enabling the lane change instruction by a gesture or a voice.

On the other hand, when it is determined that the driving mode is not the first driving mode (step S15—No), the ECU 80 rejects the second input (step S16) and ends the process without starting the travel control of the lane change. In this case, the ECU 80 may notify the occupant that the second input is not received through the display by the touch panel display 22 and/or the voice by the speaker 23.

In the second driving mode, the occupant is allowed to perform the second activity other than driving. In such a situation, various gestures and voices of the occupant can be acquired. Therefore, the ECU 80 does not perform the travel control of the lane change based on the second input in the second driving mode. Accordingly, it is possible to prevent a lane change unintended by the occupant due to the erroneous recognition of the ECU 80.

Although not illustrated, even in the third driving mode before the hands-off condition is satisfied, the ECU 80 can make the proposal for the lane change, and the approval of the occupant for the lane change proposal can be input to the input interface 70. When the input is the first input, the ECU 80 receives the first input and starts the travel control of the lane change. On the other hand, when the input is the second input, the ECU 80 rejects the second input and ends the process without starting the travel control of the lane change.

During the third driving mode, that is, during the hands-on traveling, the hands of the occupant grip the steering wheel 35 and are near the turn signal lever 71 and the like. Therefore, it is easier for the occupant to operate the turn signal lever 71 or the like than during the hands-off traveling. Therefore, in the third driving mode, no particular problem occurs even when the travel control of the lane change based on the second input is not performed.

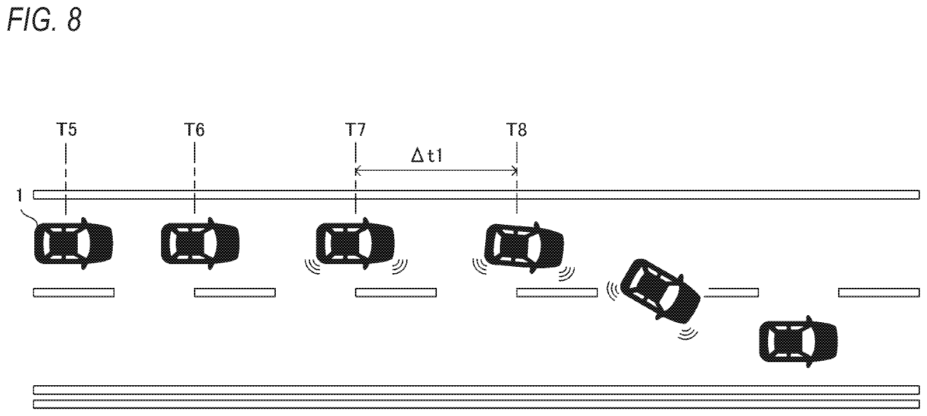

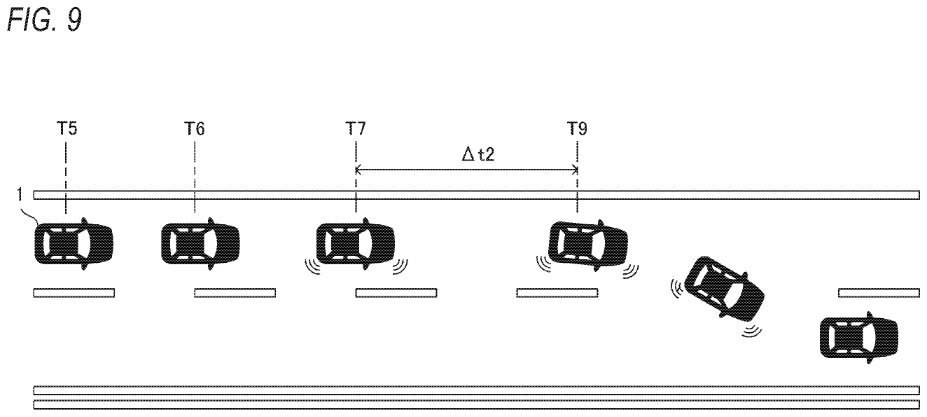

FIGS. 8 and 9 schematically illustrate a flow of the travel control of the lane change in the ALCR performed by the ECU 80.

FIG. 8 illustrates a flow of the approval of the lane change proposal based on the first input and the travel control of the lane change after the approval, in which the ECU 80 makes the proposal for the lane change at a time point T5, and the occupant operates the button 72 to perform the first input for approving the proposal at a time point T6. At a time point T7, the ECU 80 receives the first input and turns on the direction indicator of the vehicle 1. Then, at a time point T8 when a predetermined waiting time Δt1 has elapsed from the time point T7, the ECU 80 starts the travel control of the lane change based on the first input.

FIG. 9 illustrates a flow of the approval of the lane change proposal based on the second input and the travel control of the lane change after the approval, in which the ECU 80 makes the proposal for the lane change at the time point T5, and the occupant performs the second input for approving the proposal by a gesture or a voice at the time point T6. At the time point T7, the ECU 80 receives the second input and turns on the direction indicator of the vehicle 1. Then, at a time point T9 when a predetermined waiting time Δt2 has elapsed from the time point T7, the ECU 80 starts the travel control of the lane change based on the second input.

The waiting time Δt1 from the first input to the start of the travel control of the lane change and the waiting time Δt2 from the second input to the start of the travel control of the lane change are grace times for canceling the start of the travel control of the lane change. The waiting time Δt2 may be set to be the same as the waiting time Δt1, but is preferably set to be longer than the waiting time Δt1.

The lane change is roughly divided into a lane change with high priority such as a lane change due to width reduction or a lane change along a travel route to a destination, and an optional lane change based on the preference of the occupant. The optional lane change based on the preference of the occupant is, for example, a lane change for traveling in a lane different from that of the preceding vehicle, a lane change for traveling in a lane different from that of the following vehicle, a lane change for entering an overtaking lane from the traveling lane, a lane change for exiting from the overtaking lane to the traveling lane, or a lane change for evacuating to a lane adjacent to a side opposite to a merging lane side in a lane width direction before a merging point.

In the travel control of the lane change in the ALCR, the proposal of the lane change performed by the ECU 80 is preferably intended for the optional lane change. The ECU 80 may have a fourth driving mode in which the travel control of the lane change can be started without requiring the approval of the occupant, and for the lane change having a high priority, the ECU 80 starts the travel control of the lane change without going through the process of the proposal to the occupant and the approval of the proposal by the occupant, and the ECU 80 makes the proposal for the optional lane change, so that the burden on the occupant can be further reduced.

In the travel control of the lane change performed by the ECU 80, the ECU 80 detects a target existing around the vehicle 1 based on the surrounding information of the vehicle 1. The target is, for example, another vehicle, a pedestrian, an obstacle, or the like. When a target is detected around the vehicle 1, the ECU 80 interrupts the lane change, that is, interrupts the lateral movement toward the lane to be changed. Then, the lane change is resumed after the target disappears from the surroundings of the vehicle 1. When the target is continuously detected around the vehicle 1 even after a predetermined time has elapsed from the interruption of the lane change, the ECU 80 may cancel the travel control of the lane change. When the target is detected around the vehicle 1, the ECU 80 does not start the lane change based on the input of the occupant in the ALCA.

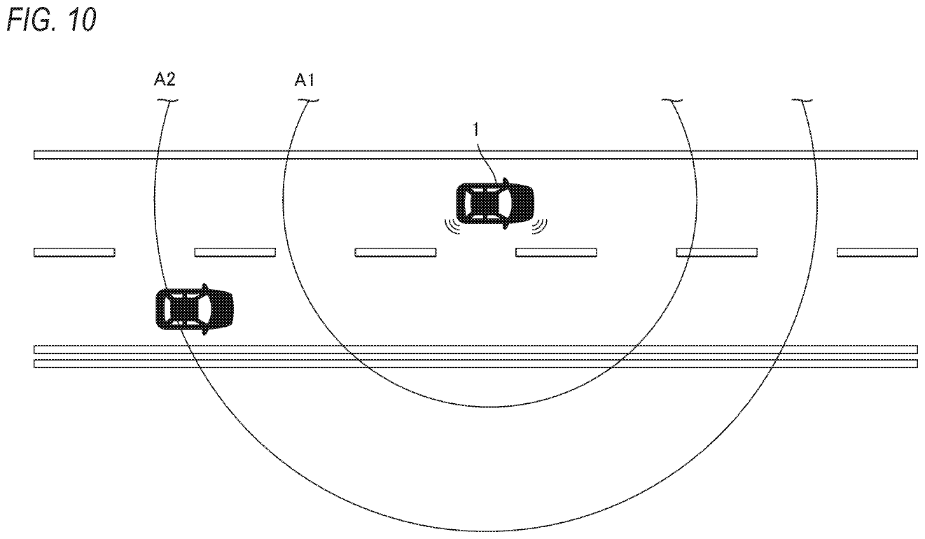

As illustrated in FIG. 10, in the travel control of the lane change based on the first input, the ECU 80 detects a target present within a first range A1 around the vehicle 1. Further, in the travel control of the lane change based on the second input, the ECU 80 detects a target present in a second range A2 around the vehicle 1. The second range A2 is preferably set to be wider than the first range A1. Even if the ECU 80 erroneously recognizes the second input by the gesture or the voice and starts the travel control of the lane change, and thus the occupant does not monitor the surroundings, the safety can be improved by setting the second range A2 to be wide.

In the travel control of the lane change based on the second input, the ECU 80 determines whether the lane change can be performed based on an attribute of a point where the vehicle is traveling. Examples of the attribute of the traveling point include a straight road, a gentle curve having a curvature radius equal to or greater than a predetermined value, a sharp curve having a curvature radius less than a predetermined value, an intersection, a merging point, and a branching point. The ECU 80 acquires the attribute of the traveling point from the map information stored in the memory of the navigation system 20, for example, and determines the attribute of the traveling point from a road surface marking such as a division line of a road surface detected from an image acquired by the external camera group 11.

Among the above attributes, a relatively wide field of view is provided to the occupant and the sensors such as the external camera group 11 and the sonar 12, and the ECU 80 performs a lane change on a straight road or a gentle curve having a relatively simple lane configuration. On the other hand, the ECU 80 interrupts the lane change at a sharp curve and an intersection where the field of view is limited or at a merging point and a branching point having a complicated lane configuration. Even if the ECU 80 erroneously recognizes the second input by the gesture or the voice and starts the travel control of the lane change, it is possible to avoid the lane change from being performed at the traveling point where the field of view is limited or the lane configuration is complicated, and it is possible to improve the safety.

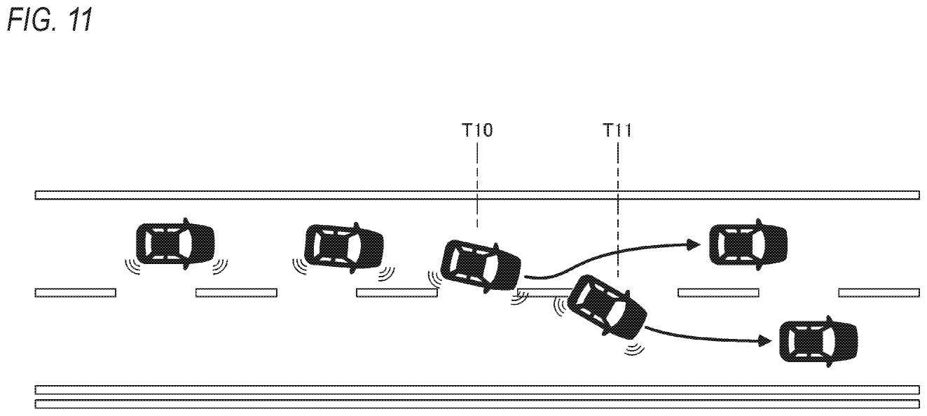

Even after the ECU 80 starts the travel control of the lane change, the occupant can intervene in the travel control of the lane change performed by the ECU 80 and cancel the lane change. FIG. 11 schematically illustrates a flow in which the ECU 80 receives the intervention by the occupant and cancels the lane change being performed.

The ECU 80 repeatedly performs a process of detecting a predetermined operation by the occupant in the travel control of the lane change. The predetermined operation is, for example, a turn signal operation of returning the turn signal lever 71 to a neutral position or inputting the turn signal lever 71 in the opposite direction, an accelerator operation, a brake operation, a steering operation toward the side opposite to the lane to be changed, or the like. At a time point T10, the predetermined operation is input by the occupant. The ECU 80 receives the predetermined operation, cancels the lane change being performed, and transfers an operation authority of the vehicle 1 to the occupant. After the authority transfer, the vehicle 1 returns to an original lane based on the operation of the occupant.

The predetermined operation may be an operation by a gesture or a voice. However, even when the predetermined operation by the gesture or the voice is detected, the ECU 80 rejects the intervention by the occupant and completes the lane change being performed when the process of the lane change has progressed considerably. When the predetermined operation is input by the occupant at a time point T11 later than the time point T10, most of the vehicle 1 enters the lane to be changed at this time. The ECU 80 completes the lane change being performed without receiving the predetermined operation by the gesture or the voice.

The ECU 80 may change a detection sensitivity of the predetermined operation in the travel control of the lane change based on the first input and a detection sensitivity of the predetermined operation in the travel control of the lane change based on the second input. Among the predetermined operations, the accelerator operation, the brake operation, and the steering operation are operations having operation amounts. Regarding these operations, the ECU 80 detects an operation of which the operation amount exceeds a threshold value as the predetermined operation, and changes the detection sensitivity of the predetermined operation by changing the threshold value between the travel control of the lane change based on the first input and the travel control of the lane change based on the second input.

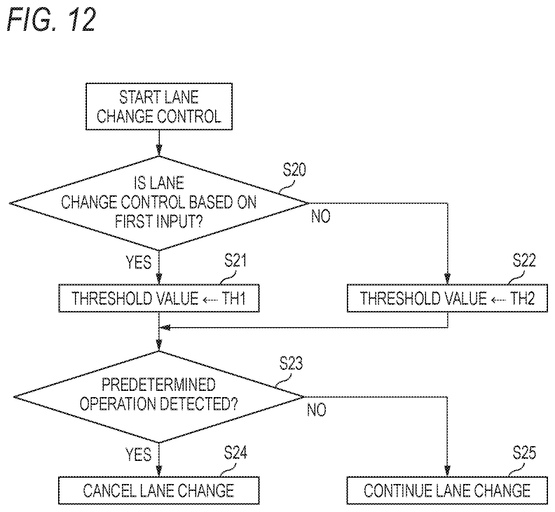

FIG. 12 illustrates a process of canceling the lane change using the threshold value, and when the travel control of the lane change is started, the ECU 80 determines whether the travel control of the lane change is based on the first input or based on the second input (step S20).

When the travel control of the started lane change is the travel control of the lane change based on the first input (step S20—Yes), the ECU 80 sets the threshold value to TH1 (step S21). On the other hand, when the started lane change is the travel control of the lane change based on the second input (step S20—No), the ECU 80 sets the threshold value to TH2 (step S22). The threshold value TH2 is a value smaller than the threshold value TH1, that is, the detection sensitivity of the predetermined operation in the travel control of the lane change based on the second input is set to be higher than the detection sensitivity of the predetermined operation in the travel control of the lane change based on the first input. The threshold value TH1 and the threshold value TH2 are set for each predetermined operation (the accelerator operation, the brake operation, the steering operation).

Then, the ECU 80 detects the predetermined operation with reference to the threshold value set in step S21 or step S22 (step S23). When the predetermined operation is detected (step S23—Yes), the ECU 80 cancels the lane change being performed (step S24) and transfers the operation authority of the vehicle 1 to the occupant. On the other hand, when the predetermined operation is not detected (step S23—No), the ECU 80 continues the lane change being performed (step S25). The ECU 80 repeats the processes from step S23 to step S25 until the lane change is completed or the lane change is canceled in step S24.

As described above, by setting the detection sensitivity of the predetermined operation in the travel control of the lane change based on the second input to be higher than the detection sensitivity of the predetermined operation in the travel control of the lane change based on the first input, even if the ECU 80 erroneously recognizes the second input by a gesture or a voice and starts the travel control of the lane change, the lane change can be quickly canceled, and the safety can be improved. It can be said that the travel control of the lane change based on the second input is more likely to be canceled than the travel control of the lane change based on the first input, but “more likely to be canceled” does not mean that the lane change is canceled and the vehicle returns to the original lane even if the lane change has progressed to a considerable extent. When the lane change has progressed to a considerable extent, the ECU 80 completes the lane change as described above.

Regarding the steering operation, in the travel control of the lane change based on the second input, the steering operation having the operation amount exceeding the threshold value TH2 and/or the gripping of the steering wheel 35 may be detected as the predetermined operation. The gripping of the steering wheel 35 is determined based on a detection result of the grip sensor 37, for example, the capacitance.

The embodiment of the present disclosure has been described above, but the present disclosure is not limited to the embodiment described above, and modifications, improvements, and the like can be made as appropriate. In the present description, at least the following matters are described. Although corresponding constituent elements or the like in the embodiment described above are illustrated in parentheses, the present disclosure is not limited thereto. (1) A control device (ECU 80) of a vehicle, the control device including a processor configured to:
acquire surrounding information of the vehicle;
receive, from an inputter (input interface 70) provided in a passenger compartment of the vehicle, a first input with contact and a second input by at least one of a gesture and a voice by an occupant of the vehicle; and
perform a travel control of the vehicle using the surrounding information and start the travel control of a lane change for performing the lane change based on at least the first input, in which
the processer is configured to start the travel control of the lane change based on the second input in a first driving mode in which gripping a steering wheel by the occupant is not required and monitoring surroundings outside the vehicle by the occupant is required.

According to the control device of the above (1), it is possible to reduce a burden on the occupant by enabling the lane change instruction by a gesture or a voice during the hands-off traveling in which the gripping the steering wheel by the occupant is not required.

(2) The control device according to (1), in which
the processer is configured not to perform the travel control of the lane change based on the second input in a second driving mode in which the gripping the steering wheel by the occupant is not required and the monitoring the surroundings outside the vehicle by the occupant is not required.

According to the control device of the above (2), it is possible to prevent the control from erroneously recognizing the gesture or the voice of the occupant, and to prevent the lane change unintended by the occupant due to the erroneous recognition.

(3) The vehicle according to (1) or (2), in which
the processer is configured not to perform the travel control of the lane change based on the second input in a third driving mode in which the gripping the steering wheel by the occupant is required and the monitoring the surroundings outside the vehicle by the occupant is required.

According to the control device of the above (3), it is relatively easy for the occupant to perform the first input during the hands-on traveling in which the occupant is required to grip the steering wheel, and no particular problem occurs even when the travel control of the lane change based on the second input is not performed. It is possible to prevent the controller from erroneously recognizing the gesture or the voice of the occupant, and to prevent the lane change unintended by the occupant due to the erroneous recognition.

(4) The control device according to (1), in which
the processer is configured to make a proposal for the lane change to the occupant based on the surrounding information, and
the second input is an approval for the proposal.

According to the control device of the above (4), it is possible to reduce the burden on the occupant by enabling the approval by a gesture or a voice with respect to the proposal of the lane change performed by the controller

(5) The control device according to (4), in which
the proposal is a proposal for a lane change for any one of purposes of traveling of the vehicle in a lane different from a lane in which a preceding vehicle travels, traveling of the vehicle in a lane different from a lane in which a following vehicle travels, entry of the vehicle from a traveling lane to an overtaking lane, exit of the vehicle from the overtaking lane to the traveling lane, and evacuation to a lane adjacent to a side opposite to a merging lane side in a lane width direction before a merging point.

According to the control device of the above (5), the controller makes a proposal for an optional lane change and approves the proposal, so that the burden on the occupant can be further reduced.

(6) The control device according to (5), in which
the processer is configured to make the proposal in a case where a fourth driving mode is set, the fourth driving mode being a driving mode in which the start of the travel control of the lane change is enabled without requiring the approval of the occupant.

According to the control device of the above (6), the burden on the occupant can be further reduced.

(7) The control device according to (1), in which
the processer is configured to cancel the travel control of the lane change in response to a predetermined operation by the occupant being detected during the travel control of the lane change, and
a detection sensitivity with which the predetermined operation is detected in the travel control of the lane change based on the second input is set to be higher than a detection sensitivity with which the predetermined operation is detected in the travel control of the lane change based on the first input.

According to the control device of the above (7), even if the controller erroneously recognizes the second input by the gesture or the voice and starts the travel control of the lane change, the lane change can be quickly canceled, and safety can be improved.

(8) The control device according to (7), in which
the predetermined operation is an acceleration and deceleration operation of which an operation amount exceeds a threshold value, and
the threshold value in the travel control of the lane change based on the second input is smaller than the threshold value in the travel control of the lane change based on the first input.

According to the control device of the above (8), the detection sensitivity of the predetermined operation in the travel control of the lane change based on the second input can be set higher than the detection sensitivity of the predetermined operation in the travel control of the lane change based on the first input.

(9) The control device according to (7), in which
the predetermined operation is steering or gripping of the steering wheel of which an operation amount exceeds a threshold value, and
the processer is configured to
   interrupt the travel control of the lane change in response to the steering having an operation amount equal to or greater than a first threshold value being detected in the travel control of the lane change based on the first input, and
   interrupt the travel control of the lane change in response to the steering or the gripping of the steering wheel having an operation amount equal to or greater than a second threshold value, which is smaller than the first threshold value, being detected in the travel control of the lane change based on the second input.

According to the control device of the above (9), the detection sensitivity of the predetermined operation in the travel control of the lane change based on the second input can be set higher than the detection sensitivity of the predetermined operation in the travel control of the lane change based on the first input.

(10) The control device according to (1), in which
the processer is configured to
   detect a target present around the vehicle based on the surrounding information,
   perform the lane change in a case where the target is not present within a first range around the vehicle in the travel control of the lane change based on the first input, and
   perform the lane change in a case where the target is not present within a second range around the vehicle in the travel control of the lane change based on the second input, and
the second range is wider than the first range.

According to the control device of the above (10), even if the processor erroneously recognizes the second input by the gesture or the voice and starts the travel control of the lane change, and thus the occupant does not monitor the surroundings, the safety can be improved by setting the second range to be wide.

(11) A control method of a vehicle, the control method including:
by a computer configured to control the vehicle,
   acquiring surrounding information of the vehicle;
      receiving, from an inputter provided in a passenger compartment of the vehicle, a first input with contact and a second input by at least one of a gesture and a voice by an occupant of the vehicle; and
      performing a travel control of the vehicle using the surrounding information and start the travel control of a lane change for performing the lane change based on at least the first input, in which
      the travel control of the lane change is started based on the second input in a first driving mode in which gripping a steering wheel by the occupant is not required and monitoring surroundings outside the vehicle by the occupant is required.

(12) A non-transitory computer-readable storage medium storing a program for causing a computer configured to control a vehicle to execute a process, the process including:
acquiring surrounding information of the vehicle;
receiving, from an inputter provided in a passenger compartment of the vehicle, a first input with contact and a second input by at least one of a gesture and a voice by an occupant of the vehicle; and
performing a travel control of the vehicle using the surrounding information and start the travel control of a lane change for performing the lane change based on at least the first input, in which
the travel control of the lane change is started based on the second input in a first driving mode in which gripping a steering wheel by the occupant is not required and monitoring surroundings outside the vehicle by the occupant is required.

According to the control method of the above (11) and the storage medium of the above (12), it is possible to reduce a burden on the occupant by enabling the lane change instruction by a gesture or a voice during the hands-off traveling in which the gripping the steering wheel by the occupant is not required.

What is claimed is:

1. A control device of a vehicle, the control device comprising a processor configured to:
acquire surrounding information of the vehicle;
receive, from an inputter provided in a passenger compartment of the vehicle, a first input with contact and a second input by at least one of a gesture and a voice by an occupant of the vehicle; and
perform a travel control of the vehicle using the surrounding information and start the travel control of a lane change for performing the lane change based on at least the first input, wherein
the processor is configured to start the travel control of the lane change based on the second input in a first driving mode in which gripping a steering wheel by the occupant is not required and monitoring surroundings outside the vehicle by the occupant is required.

2. The control device according to claim 1, wherein
the processor is configured not to perform the travel control of the lane change based on the second input in a second driving mode in which the gripping the steering wheel by the occupant is not required and the monitoring the surroundings outside the vehicle by the occupant is not required.

3. The control device according to claim 1, wherein
the processor is configured not to perform the travel control of the lane change based on the second input in a third driving mode in which the gripping the steering wheel by the occupant is required and the monitoring the surroundings outside the vehicle by the occupant is required.

4. The control device according to claim 1, wherein
the processor is configured to make a proposal for the lane change to the occupant based on the surrounding information, and
the second input is an approval for the proposal.

5. The control device according to claim 4, wherein
the proposal is a proposal for a lane change for any one of purposes of traveling of the vehicle in a lane different from a lane in which a preceding vehicle travels, traveling of the vehicle in a lane different from a lane in which a following vehicle travels, entry of the vehicle from a traveling lane to an overtaking lane, exit of the vehicle from the overtaking lane to the traveling lane, and evacuation to a lane adjacent to a side opposite to a merging lane side in a lane width direction before a merging point.

6. The control device according to claim 5, wherein
the processor is configured to make the proposal in a case where a fourth driving mode is set, the fourth driving mode being a driving mode in which the start of the travel control of the lane change is enabled without requiring the approval of the occupant.

7. The control device according to claim 1, wherein
the processor is configured to cancel the travel control of the lane change in response to a predetermined operation by the occupant being detected during the travel control of the lane change, and
a detection sensitivity with which the predetermined operation is detected in the travel control of the lane change based on the second input is set to be higher than a detection sensitivity with which the predetermined operation is detected in the travel control of the lane change based on the first input.

8. The control device according to claim 7, wherein
the predetermined operation is an acceleration and deceleration operation of which an operation amount exceeds a threshold value, and
the threshold value in the travel control of the lane change based on the second input is smaller than the threshold value in the travel control of the lane change based on the first input.

9. The control device according to claim 7, wherein
the predetermined operation is steering or gripping of the steering wheel of which an operation amount exceeds a threshold value, and
the processor is configured to
interrupt the travel control of the lane change in response to the steering having an operation amount equal to or greater than a first threshold value being detected in the travel control of the lane change based on the first input, and
interrupt the travel control of the lane change in response to the steering or the gripping of the steering wheel having an operation amount equal to or greater than a second threshold value, which is smaller than the first threshold value, being detected in the travel control of the lane change based on the second input.

10. The control device according to claim 1, wherein
the processor is configured to
detect a target present around the vehicle based on the surrounding information,
perform the lane change in a case where the target is not present within a first range around the vehicle in the travel control of the lane change based on the first input, and
perform the lane change in a case where the target is not present within a second range around the vehicle in the travel control of the lane change based on the second input, and
the second range is wider than the first range.

11. A control method of a vehicle, the control method comprising:
by a computer configured to control the vehicle,
acquiring surrounding information of the vehicle;
receiving, from an inputter provided in a passenger compartment of the vehicle, a first input with contact and a second input by at least one of a gesture and a voice by an occupant of the vehicle; and
performing a travel control of the vehicle using the surrounding information and start the travel control of a lane change for performing the lane change based on at least the first input, wherein
the travel control of the lane change is started based on the second input in a first driving mode in which gripping a steering wheel by the occupant is not required and monitoring surroundings outside the vehicle by the occupant is required.

12. A non-transitory computer-readable storage medium storing a program for causing a computer configured to control a vehicle to execute a process, the process comprising:
acquiring surrounding information of the vehicle;
receiving, from an inputter provided in a passenger compartment of the vehicle, a first input with contact and a second input by at least one of a gesture and a voice by an occupant of the vehicle; and
performing a travel control of the vehicle using the surrounding information and start the travel control of a lane change for performing the lane change based on at least the first input, wherein
the travel control of the lane change is started based on the second input in a first driving mode in which gripping a steering wheel by the occupant is not required and monitoring surroundings outside the vehicle by the occupant is required.
